(19) United States
(12) Patent Application Publication
(10) Pub. No.: US 2026/0086064 A1
(43) Pub. Date: Mar. 26, 2026

(54) GAS SENSOR

(71) Applicant: NITERRA CO., LTD., Nagoya-shi (JP)

(72) Inventors: Masashi NOMURA, Nagoya-shi (JP); Motohiko NAKAMURA, Nagoya-shi (JP)

(73) Assignee: NITERRA CO., LTD., Nagoya-shi (JP)

(21) Appl. No.: 18/986,985

(22) Filed: Dec. 19, 2024

(30) Foreign Application Priority Data
Dec. 27, 2023 (JP) 2023-220372
Sep. 20, 2024 (JP) 2024-163222

(51) Int. Cl. G01N 27/407; G01N 27/406

(52) U.S. Cl. CPC G01N 27/4078; G01N 27/4062; G01N 27/4077

(57) ABSTRACT

A gas sensor 10 including: a sensor element 20 extending in an axial-line O direction and having an electrode pad 21a, 21b at a main surface 20m1, 20m2; a metal terminal 71 extending in the axial-line direction; a separator 50 having a storage portion 50h in which the rear end side of the sensor element and the metal terminal are stored; and a grommet 47 located on a rear end side relative to the separator, wherein the storage portion has a taper surface 50s whose diameter expands toward a direction perpendicular to the main surface as approaching a rearward-facing surface of the separator, the grommet has a protrusion 47p on a front end side, and a front end of the protrusion is fitted into a rear end side relative to a front end of the taper surface, along the axial-line direction, and the metal terminal contacts with the protrusion.

### BACKGROUND

### 1. Field of the Disclosure

The present disclosure relates to a gas sensor suitably used for detecting the concentration of a specific gas contained in combustion gas or exhaust gas of, for example, a combustor, an internal combustion engine, or the like.

### 2. Description of Related Art

As a gas sensor for detecting the concentration of oxygen or NOx in exhaust gas of an automobile or the like, a gas sensor having a plate-shaped sensor element using a solid electrolyte is known.

This type of gas sensor may be configured such that a plurality of electrode pads arranged in the width direction are provided on the rear-end sides of opposed main surfaces of a plate-shaped sensor element, and metal terminals electrically contact with the respective electrode pads, to take sensor output signals from the sensor element to outside (Patent Document 1).

In the gas sensor in Patent Document 1, the metal terminals are retained in an insulating connector (separator) of a two-divided type. This connector is configured such that the respective metal terminals are stored in box-type housings having the same shape and the housings are fitted to each other and fixed by a metal clamp. Then, when the rear end side of the sensor element is inserted into an insertion hole of the connector, the metal terminals inside the connector electrically contact with electrode pads.

On the rear end side of the connector, the insertion hole has a diameter expanding radially outward in a direction perpendicular to main surfaces of the sensor element as approaching a rearward-facing surface. Thus, the metal terminals led out to the rear end side of the connector are inhibited from interfering with the inner surface of the connector.

[Patent Document 1] Japanese Patent Application Laid-Open (kokai) No. 2014-209104

### 3. Problem(s) to be Solved

When the rear end side of the connector has an expanding diameter, the intervals between the connector and the metal terminals become great, and thus it has been found that the metal terminals sway in the connector due to vibration during usage of the gas sensor or the like and are likely to be broken.

### SUMMARY OF THE DISCLOSURE

An object of the present disclosure is to provide a gas sensor configured to inhibit breakage of metal terminals on the rear end side of a separator.

In order to solve the above problem, a gas sensor of the present disclosure is a gas sensor including: a plate-shaped sensor element extending in an axial-line direction and having an electrode pad at a main surface on a rear end side thereof; a metal terminal extending in the axial-line direction and electrically connected to the electrode pad; a separator having a storage portion which penetrates in the axial-line direction and in which the rear end side of the sensor element and the metal terminal are stored, thus retaining the metal terminal; and a grommet located on a rear end side relative to the separator, wherein the storage portion has a taper surface whose diameter expands toward a direction perpendicular to the main surface as approaching a rearward-facing surface of the separator, the grommet has a protrusion on a front end side, and a front end of the protrusion is fitted into a rear end side relative to a front end of the taper surface, along the axial-line direction, and the metal terminal contacts with the protrusion.

With this gas sensor, the protrusion provided on the front end side of the grommet is fitted into the separator, so that the metal terminal contacts with the protrusion.

Thus, the metal terminal is retained by the protrusion, whereby vibration of the metal terminal is inhibited, so that breakage of the metal terminal can be inhibited.

In the gas sensor according to the present disclosure, the front end of the protrusion may be fitted into the separator so as to reach a front end side relative to ½ of a length L in the axial-line direction of the taper surface.

With this gas sensor, the protrusion may have an increased or improved contact with the metal terminal.

In the gas sensor according to the present disclosure, the protrusion may have a grommet hole into which the metal terminal is inserted, and the metal terminal may contact with the protrusion, inside the grommet hole.

In the gas sensor according to the present disclosure, a side surface of the protrusion may be tapered toward a front end side along the taper surface, and the metal terminal may be held between the side surface of the protrusion and the taper surface.

In the gas sensor according to the present disclosure, the protrusion may be located on an inner side relative to the metal terminal.

In the gas sensor according to the present disclosure, the protrusion may be located between the metal terminal and the taper surface.

The present disclosure makes it possible to provide a gas sensor configured to inhibit breakage of metal terminals on the rear end side of a separator.

Additional features and advantages of the present disclosure may be described further below. This summary section is meant merely to illustrate certain features of the disclosure, and is not meant to limit the scope of the disclosure in any way. The failure to discuss a specific feature or embodiment of the disclosure, or the inclusion of one or more features in this summary section, should not be construed to limit the claims.

### BRIEF DESCRIPTION OF THE DRAWINGS

The figures contained herein are provided only by way of example and not by way of limitation.

FIG. 1 is a sectional view of a gas sensor according to a first embodiment of the present disclosure.

FIG. 2 is a perspective view showing a separator.

FIG. 3 is a sectional view taken along line A-A in FIG. 2.

FIG. 4 is a perspective view showing a metal terminal.

FIG. 5 is a perspective view of a grommet as seen from a front end side.

FIGS. 6A and 6B are enlarged sectional views around a grommet and a separator.

FIG. 7 is a perspective view of a grommet in a modification of the first embodiment.

FIG. 8 is a perspective view of a grommet in a second embodiment as seen from a front end side.

FIGS. 9A and 9B are enlarged sectional views around a grommet and a separator in the second embodiment.

FIG. 10 is a perspective view of a grommet in a third embodiment as seen from a front end side.

FIGS. 11A and 11B are enlarged sectional views around a grommet and a separator in the third embodiment.

FIG. 12 is a perspective view of a grommet in a fourth embodiment as seen from a front end side.

FIGS. 13A and 13B are enlarged sectionals view around a grommet and a separator in the fourth embodiment.

### DESCRIPTION OF REFERENCE NUMERALS

Reference numerals used to identify various features in the drawings include, but are not limited to, the following:
10 gas sensor
20 sensor element
20m1, 20m2 main surface of the sensor element
21a, 21b electrode pad
47, 147, 247, 347 grommet
47p, 47p2, 147p, 247p, 347p protrusion
47a, 147a, 247a, 347a grommet hole
50 separator
50h storage portion
50s taper surface
71 metal terminal
O axial line

### DETAILED DESCRIPTION

Hereinafter, embodiments of the present disclosure will be described with reference to the drawings.

It is to be understood that both the foregoing general description and the following detailed description are exemplary and are intended to provide further explanation of the claims. Accordingly, various changes, modifications, and equivalents of the methods, apparatuses, and/or systems described herein will be apparent to those of ordinary skill in the art. Moreover, descriptions of well-known functions and constructions may be omitted for increased clarity and conciseness.

The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

If used herein, “about,” “approximately,” “substantially,” and “significantly” will be understood by a person of ordinary skill in the art and will vary in some extent depending on the context in which they are used. If there are uses of the term which are not clear to persons of ordinary skill in the art given the context in which it is used, “about” and “approximately” will mean plus or minus ≤10% of particular term, and “substantially” and “significantly” will mean plus or minus >10% of the particular term.

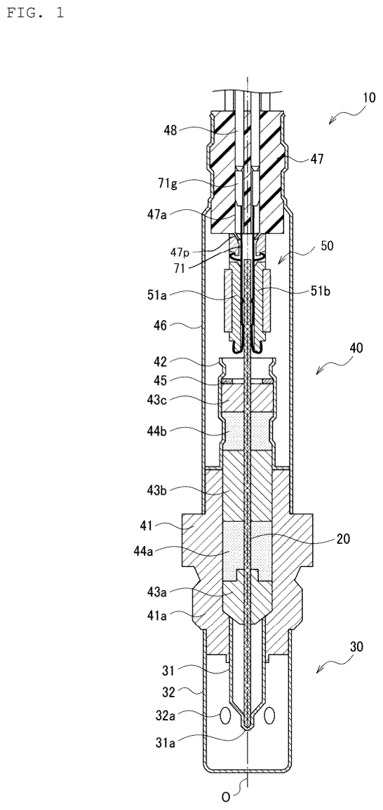

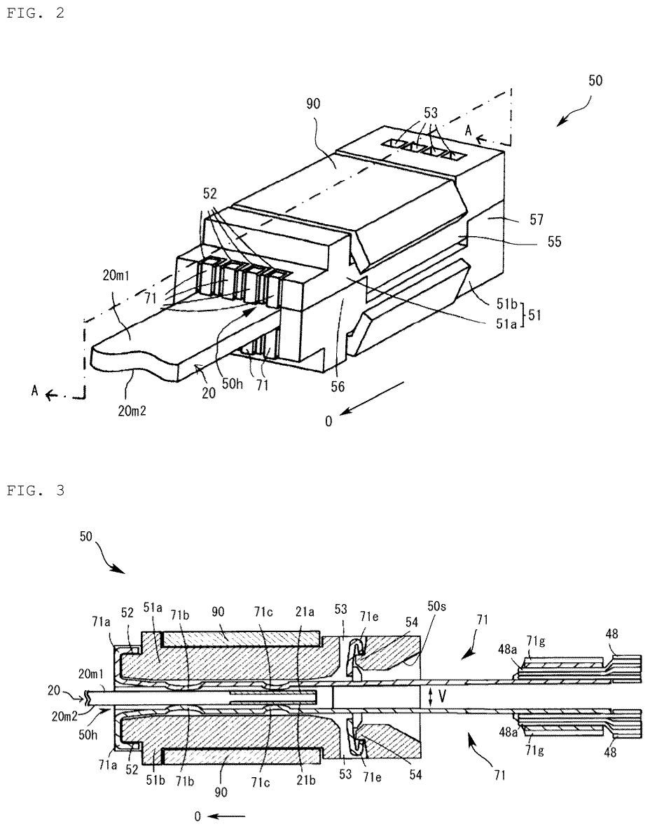

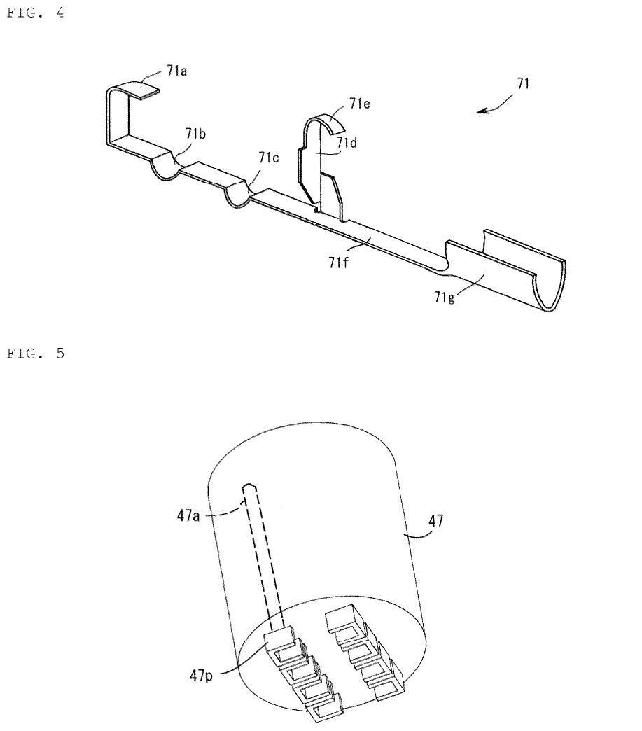

FIG. 1 is a sectional view along the axial-line O direction of a gas sensor (sensor) 10 according to an embodiment of the present disclosure. FIG. 2 is a perspective view showing a separator 50. FIG. 3 is a sectional view taken along line A-A in FIG. 2. FIG. 4 is a perspective view showing a metal terminal 71.

As shown in FIG. 1, the gas sensor 10 includes a sensor element 20 which measures a specific gas component in a measurement target gas, a protector 30 for protecting a front end of the sensor element 20, and a sensor assembly 40 including a separator 50 which stores a rear end side of the sensor element 20. The gas sensor 10 is attached, for example, to an exhaust pipe of a vehicle and is used for measuring a gas component such as NOx or O₂ contained in the measurement target gas (exhaust gas).

The sensor element 20 is a plate-shaped element having a long thin size and extending in the axial-line-O direction, and is formed by laminating layers such as a ceramic substrate made of an oxygen ion conductive solid electrolyte layer of zirconia (ZrO₂) or the like. An end on the protector 30 side of the sensor element 20 is referred to as a front end, and an end on the separator 50 side is referred to as a rear end.

A plurality of electrode pads 21a, 21b (FIG. 3) are formed at main surfaces 20m1, 20m2 (FIG. 2 and FIG. 3) on the rear end side of the sensor element 20.

Specifically, as shown in FIG. 3, at one main surface 20m1 of the sensor element 20, the plurality of electrode pads 21a are arranged separately from each other in the width direction of the sensor element 20, and similarly, at the other main surface 20m2 of the sensor element 20, the plurality of electrode pads 21b are arranged separately from each other in the width direction of the sensor element 20.

The plurality of electrode pads may be arranged at only one main surface 20m1 or 20m2 of the sensor element 20.

The electrode pads 21a, 21b are used for applying voltage to the sensor element 20, for outputting detection signals of the sensor element 20, or for energizing a heater in a case where the sensor element 20 has the heater.

As shown in FIG. 1, the protector 30 is provided so as to surround the front end of the sensor element 20. The protector 30 includes an inner protector 31 covering the front end of the sensor element 20, and an outer protector 32 covering the inner protector 31. The inner protector 31 is formed in a tubular shape and has, at the front end of the sensor element 20, an inner gas introduction hole 31a through which the measurement target gas is introduced. The outer protector 32 is formed in a bottomed tubular shape and has, in a side surface, outer gas introduction holes 32a through which the measurement target gas is introduced. The inner protector 31 and the outer protector 32 are made of metal such as SUS, for example.

The sensor assembly 40 includes a metal shell 41 made of metal, an inner casing 42 and an outer casing 46 having cylindrical shapes and welded and fixed to the metal shell 41, and the separator 50 connected to the rear end of the sensor element 20.

The metal shell 41 is attached to, for example, an exhaust pipe of a vehicle, via an external thread part 41a. Inside the inner casing 42, a plurality of ceramic sleeves 43a to 43c, and powder filled layers 44a, 44b such as talc provided between the ceramic sleeves 43a, 43b and between the ceramic sleeves 43b, 43c, are sealed in a state of being held between a metal ring 45 and an inner wall of the metal shell 41.

The outer casing 46 covers the inner casing 42, the sensor element 20, and the separator 50. An opening of the rear end side of the outer casing 46 is closed by a grommet 47 made of rubber. A lead wire 48 is connected to a connection portion 71g (FIG. 4) on the rear end side of the metal terminal 71 by crimping or the like, and the lead wire 48 passes through a grommet hole 47a penetrating the grommet 47 in the axial-line-O direction, so as to be led to the outside from the rear end of the grommet 47.

In the grommet hole 47a, the connection portion 71g of the metal terminal 71 and the lead wire 48 are inserted.

Next, the separator 50 will be described. As shown in FIG. 2, the separator 50 includes a first member 51a and a second member 51b made of ceramic such as an alumina sintered body, and a clamp 90 which is made of metal and which clamps and fixes the first member 51a and the second member 51b.

Each metal terminal 71 is retained at the first member 51a or the second member 51b, and the metal terminals 71 are arranged so as to contact with the electrode pads 21a, 21b of the sensor element 20 in a one-to-one opposed manner.

At each of the first member 51a and the second member 51b, four metal terminals 71 are retained so as to be arranged in the width direction perpendicular to the longitudinal direction (=axial-line-O direction) of the metal terminals 71. The first member 51a and the second member 51b have the same box-type shape, and therefore the same components thereof are denoted by the same reference characters in the description. The first member 51a and the second member 51b are collectively referred to as a housing 51.

The housing 51 includes a storage portion 50h penetrating in the axial-line-O direction, four engagement grooves 52 with which the front end sides of the metal terminals 71 are engaged, four insertion holes 53 into which erected portions 71d at center parts of the metal terminals 71 are inserted, and engagement portions 54 which are formed in the insertion holes 53 and with which the metal terminals 71 are engaged.

The housing 51 has a projection 55 at a side surface on one side in the width direction across the sensor element 20, and has, at the other side surface, restriction members 56, 57 for restricting the thickness-direction distance between the first member 51a and the second member 51b (see FIG. 2). The projection 55 is inserted into a recess between the restriction member 56 and the restriction member 57 of the housing 51 on the opposite side, thus restricting the positions of the first member 51a and the second member 51b in the thickness direction relative to each other.

As shown in FIG. 4, the metal terminal 71 is a member made of metal and retained by the housing 51 at a position one-to-one opposed to each electrode pad 21a, 21b of the sensor element 20, and has a plate-shaped body portion 71f. The body portion 71f has a front end 71a having a bent shape to be engaged with the engagement groove 52, a protrusion 71b bent and protruding toward the sensor element 20, a contact portion 71c bent and protruding toward the sensor element 20 so as to contact with each electrode pad 21a, 21b, and the erected portion 71d to be inserted into the insertion hole 53. In addition, the body portion 71f integrally has, on the rear end side, a connection portion 71g to which a plurality of wire elements 48a of the lead wire 48 are crimped and retained outside the separator 50.

The rear end side of the metal terminal 71 relative to the erected portion 71d is led to the outside of the separator 50.

The protrusion 71b and the contact portion 71c are arranged along the longitudinal direction of the metal terminal 71, and the contact portion 71c is located closer to the connection portion 71g than the protrusion 71b is. The protrusion 71b and the contact portion 71c are formed to be elastically deformable. The erected portion 71d has an engagement portion 71e having a bent shape to be engaged with the engagement portion 54.

The contact portion 71c of the metal terminal 71 retained at the first member 51a contacts with the electrode pad 21a of the sensor element 20 in a one-to-one opposed manner, and the contact portion 71c of the metal terminal 71 retained at the second member 51b contacts with the electrode pad 21b of the sensor element 20 in a one-to-one opposed manner (FIG. 3).

On the other hand, as shown in FIG. 3, the electrode pads 21a, 21b are formed over a range from the rear end of the sensor element 20 to a position between the contact portion 71c and the protrusion 71b.

As shown in FIG. 2, the clamp 90 is formed by bending a plate-shaped metal, and has an elastic force that can press the first member 51a and the second member 51b in directions to approach each other while clamping them. When the first member 51a and the second member 51b are clamped with the elastic force, the restriction members 56, 57 of the first member 51a contact with the second member 51b, and the restriction members 56, 57 of the second member 51b contact with the first member 51a. Thus, the distance between the first member 51a and the second member 51b is fixed.

When the clamp 90 clamps the first member 51a and the second member 51b in a state in which the sensor element 20 and the metal terminals 71 are sandwiched between the first member 51a and the second member 51b such that the contact portions 71c of the metal terminals 71 are opposed to the electrode pads 21a, 21b of the sensor element 20, the protrusions 71b and the contact portions 71c are elastically deformed by the pressing force from the clamp 90, so that the sensor element 20 is held therebetween and fixed.

At this time, since the elastically deformed protrusion 71b and contact portion 71c press the sensor element 20, the sensor element 20 can be assuredly held therebetween and fixed. In addition, since the contact portion 71c is elastically deformed, electric contact between the contact portion 71c and each electrode pad 21a, 21b can be assuredly kept.

Next, features of the present disclosure will be described.

First, as shown in FIG. 3, the separator 50 includes the storage portion 50h penetrating in the axial-line-O direction, and the storage portion 50h stores the rear end side of the sensor element 20 and the metal terminals 71.

More specifically, the storage portion 50h has, at the front end surface of the housing 51, a rectangular opening slightly larger than the outer shape of the sensor element 20, and communicates with the insertion holes 53 on the rear end side. The storage portion 50h may be an insertion hole having openings only at the front end and the rear end of the housing 51.

In this example, the storage portion 50h is formed by recessing parts of the opposed surfaces of the first member 51a and the second member 51b.

Further, the storage portion 50h has a taper surface 50s (also referred to as a diameter-expanding portion 50s) whose diameter expands toward a direction (up-down direction in FIG. 3) perpendicular to the two main surfaces 20m1, 20m2 of the sensor element 20 as approaching the rearward-facing surface of the separator 50.

The wording “expanding toward the direction perpendicular to the main surfaces 20m1, 20m2” means that the expanding direction has a direction component perpendicular to the main surfaces 20m1, 20m2, and includes a case where the degree of diameter expansion of the diameter-expanding portion 50s is different among locations. Examples include a case where the diameter-expanding portion 50s is not parallel to the main surfaces 20m1, 20m2, a case where the diameter-expanding portion 50s has a curved surface, and a case where the diameter-expanding portion 50s is parallel to the main surfaces 20m1, 20m2 but the front edge or the rear edge of the diameter-expanding portion 50s is not parallel to the main surfaces 20m1, 20m2 (lengths or positions of segments appearing when the diameter-expanding portion 50s is cut along the main surfaces 20m1, 20m2 are different from each other).

In this example, the metal terminals 71 have plate shapes and the plate surfaces face the main surfaces 20m1, 20m2 of the sensor element 20. The plate-shaped metal terminals 71 sway in a direction perpendicular to the plate surfaces. Therefore, due to vibration during usage of the gas sensor 10 or the like, the metal terminals 71 sway in a direction perpendicular to the main surfaces 20m1, 20m2 (V direction in FIG. 3) and are likely to be broken.

Therefore, as shown in FIG. 1, protrusions 47p provided on the front end side of the grommet 47 are fitted into the separator 50, so that the metal terminals 71 contact with the protrusions 47p.

Thus, the metal terminals 71 are retained by the protrusions 47p, whereby vibration of the metal terminals 71 is inhibited, so that breakage of the metal terminals 71 can be inhibited.

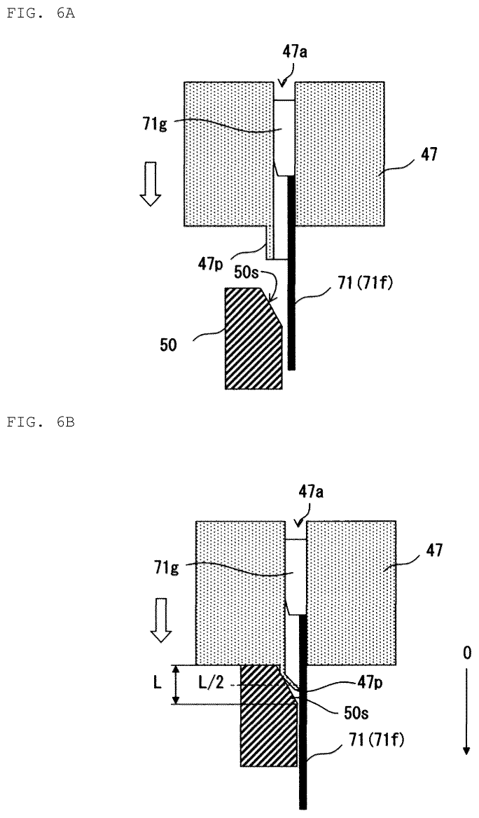

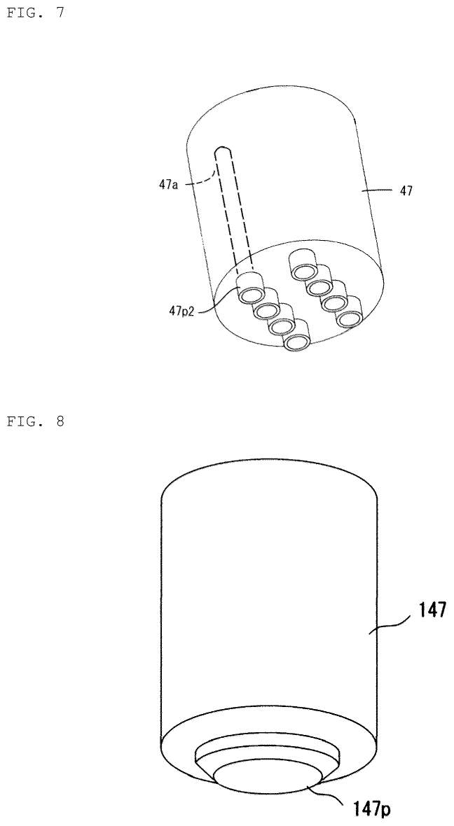

With reference to FIG. 5 and FIGS. 6A and 6B, the function of the protrusions 47p of the grommet 47 will be described in more detail.

FIG. 5 is a perspective view of the grommet 47 as seen from the front end side. FIGS. 6A and 6B are partially enlarged sectional views around the grommet 47 and the separator 50.

As shown in FIG. 5, eight protrusions 47p, each erected in a U shape, are formed on a front end side of the grommet 47. Further, each protrusion 47p may have a corresponding grommet hole 47a extending from the front end side of the grommet 47 to a back end side of the grommet 47.

In this example, as shown in FIG. 2, four (eight in total) metal terminals 71 are provided at each of the main surfaces 20m1, 20m2 of the sensor element 20. Each metal terminal 71 is inserted into a grommet hole 47a (FIG. 1).

The protrusions 47p are arranged so as to respectively surround each grommet hole 47a and such that opening sides of the U shapes face each other toward the radially inner side of the grommet 47.

As shown in FIG. 6A, the metal terminal 71 attached to the separator 50 and crimped with the lead wire 48 (not shown) in the connection portion 71g in advance is inserted into the grommet hole 47a from the front end side of the grommet 47. Here, the grommet hole 47a has a hole diameter that allows the large-diameter connection portion 71g to be inserted, and the body portion 71f (shown with a thicker line) of the metal terminal 71 has a smaller thickness than the connection portion 71g and therefore is displaced toward the radially inner side of the grommet hole 47a.

That is, as shown in FIG. 6A, before the protrusion 47p is fitted into the separator 50, there is a gap (unlabeled) between a radially outer side wall of the protrusion 47p and the body portion 71f, and the metal terminal 71 is not retained by the protrusion 47p.

Then, as shown in FIG. 6B, as the grommet 47 is further advanced, the protrusion 47p is fitted into the separator 50, so that the radially outer side wall of the protrusion 47p is deformed (bent) radially inward along the taper surface 50s of the separator 50, thus contacting with the metal terminal 71 as shown.

Here, the front end of the protrusion 47p is fitted into the rear end side relative to the front end of the taper surface 50s, along the axial-line-O direction.

Thus, the protrusion 47p can be assuredly deformed to contact with the metal terminal 71. In particular, the front end of the protrusion 47p may be fitted into the separator 50 so as to reach the front end side relative to ½ (or longer) of a length L in the axial-line-O direction of the taper surface 50s, and this is preferable because the protrusion 47p can more assuredly come in contact with the metal terminal 71.

As described above, in the first embodiment, the protrusion 47p has the grommet hole 47a (surrounds the grommet hole 47a), and the metal terminal 71 contacts with the protrusion 47p, inside the grommet hole 47a.

FIG. 7 shows a grommet 47 in a modification of the first embodiment; namely, cylindrical protrusions 47p2 respectively surround peripheries of the grommet holes 47a.

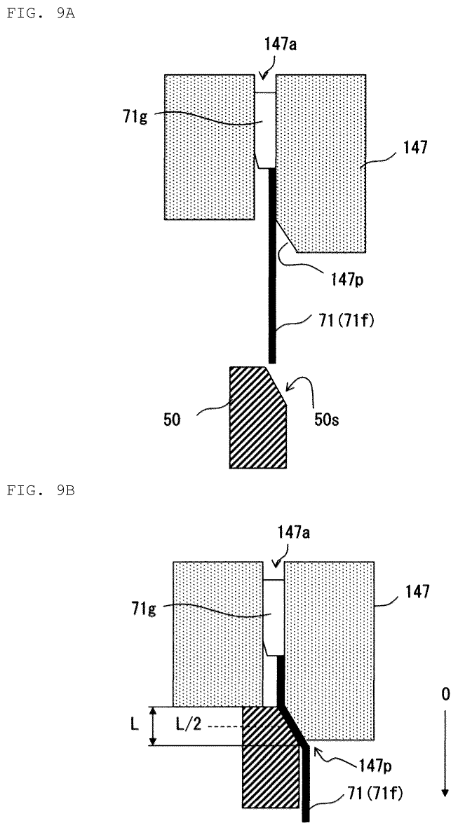

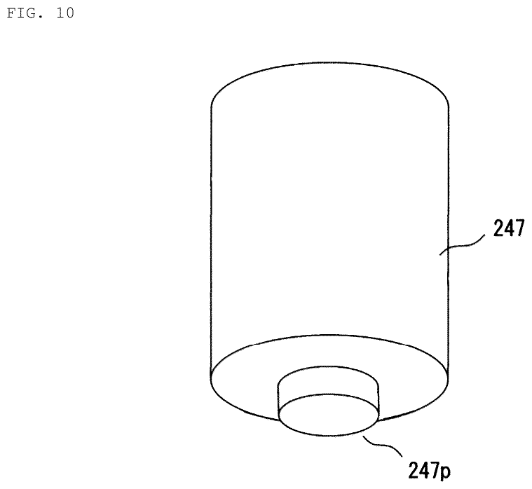

Next, with reference to FIG. 8 and FIGS. 9A and 9B, the second embodiment of the present disclosure will be described. FIG. 8 is a perspective view of the grommet 147 in the second embodiment as seen from a front end side. FIGS. 9A and 9B are partially enlarged sectional views around the grommet 147 and the separator 50 in the second embodiment.

The second embodiment is the same as the first embodiment except that the structure of the grommet 147 is different. Therefore, the other parts are denoted by the same reference characters and are not shown in the drawings, and the description thereof is omitted.

FIG. 8 and FIGS. 9A and 9B correspond to FIG. 5 and FIGS. 6A and 6B in the first embodiment.

As shown in FIG. 8, one protrusion 147p protruding in a substantially cylindrical shape is formed at the center on the front end side of the grommet 147. A side surface at a corner of the protrusion 147p is chamfered so as to form a taper shape tapered toward the front end along the taper surface 50s.

As shown in FIG. 9A, the metal terminal 71 attached to the separator 50 and crimped with the lead wire 48 (not shown) in the connection portion 71g in advance is inserted into a grommet hole 147a from the front end side of the grommet 147.

Then, as shown in FIG. 9B, as the grommet 147 is further advanced, the protrusion 147p is fitted into the separator 50. At this time, the metal terminal 71 contacts with the protrusion 147p (side surface) and the taper surface 50s, so that the metal terminal 71 is deformed into a shape along the protrusion 147p and the taper surface 50s, thus being held therebetween.

Also in the second embodiment, the front end of the protrusion 147p is fitted into the rear end side relative to the front end of the taper surface 50s, along the axial-line-O direction.

Thus, the metal terminals 71 surely contact with the protrusions 147p.

As described above, in the second embodiment, the side surface of the protrusion 147p is tapered toward the front end side along the taper surface 50s, and the metal terminal 71 is held between the side surface of the protrusion 147p and the taper surface 50s.

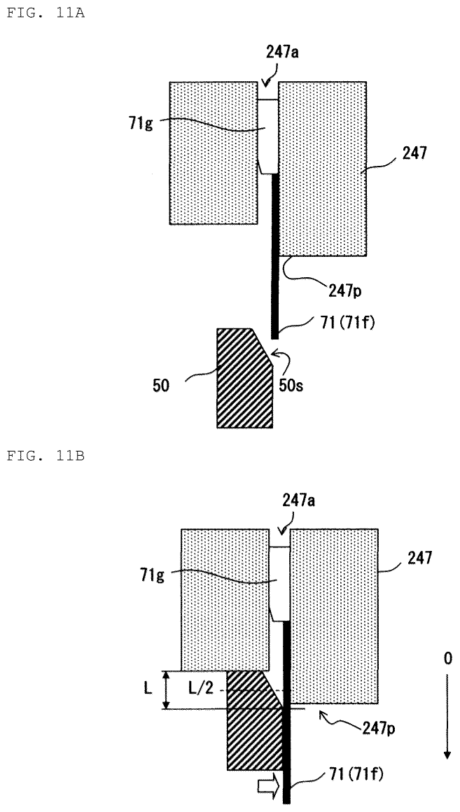

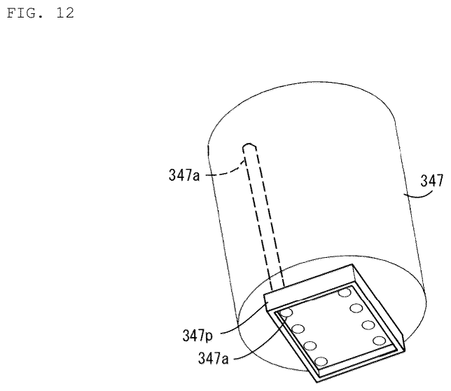

Next, with reference to FIG. 10 and FIGS. 11A and 11B, the third embodiment of the present disclosure will be described. FIG. 10 is a perspective view of the grommet 247 in the third embodiment as seen from a front end side. FIGS. 11A and 11B are partially enlarged sectional views around the grommet 247 and the separator 50 in the third embodiment.

The third embodiment is the same as the first embodiment except that the structure of the grommet 247 is different. Therefore, the other parts are denoted by the same reference characters and are not shown in the drawings, and the description thereof is omitted.

FIG. 10 and FIGS. 11A and 11B correspond to FIG. 5 and FIGS. 6A and 6B in the first embodiment.

As shown in FIG. 10, one protrusion 247p protruding in a substantially cylindrical shape is formed at the center on the front end side of the grommet 247. The protrusion 247p is formed such that a corner thereof is not chamfered, unlike the protrusion 147p in the second embodiment, and the protrusion 247p has a smaller diameter than the protrusion 147p.

As shown in FIG. 11A, the metal terminal 71 attached to the separator 50 and crimped with the lead wire 48 (not shown) in the connection portion 71g in advance is inserted into a grommet hole 247a from the front end side of the grommet 247.

Then, as shown in FIG. 11B, as the grommet 247 is further advanced, the protrusion 247p is fitted into the separator 50. At this time, while the metal terminal 71 contacts with the taper surface 50s, the metal terminal 71 is pressed toward the protrusion 247p (rightward in FIG. 11B), to come into contact with the protrusion 247p.

Also in the third embodiment, the front end of the protrusion 247p is fitted into the rear end side relative to the front end of the taper surface 50s, along the axial-line-O direction.

Thus, the metal terminals 71 surely contact with the protrusions 247p.

In the third embodiment, the protrusion 247p and the taper surface 50s are separate from each other in the radial direction.

As described above, in the third embodiment, the protrusion 247p is located on the inner side relative to the metal terminal 71.

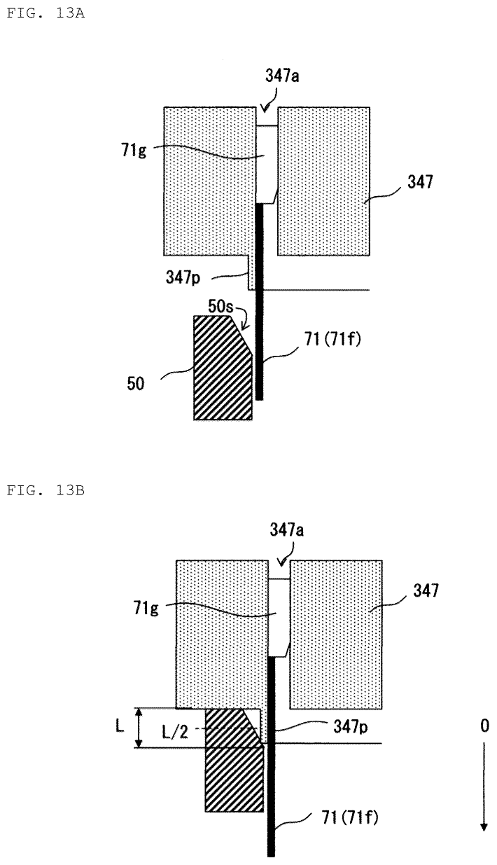

Next, with reference to FIG. 12 and FIGS. 13A and 13B, the fourth embodiment of the present disclosure will be described. FIG. 12 is a perspective view of the grommet 347 in the fourth embodiment as seen from a front end side. FIGS. 13A and 13B are partially enlarged sectional views around the grommet 347 and the separator 50 in the fourth embodiment.

The fourth embodiment is the same as the first embodiment except that the structure of the grommet 347 is different. Therefore, the other parts are denoted by the same reference characters and are not shown in the drawings, and the description thereof is omitted.

FIG. 12 and FIGS. 13A and 13B correspond to FIG. 5 and FIGS. 6A and 6B in the first embodiment.

As shown in FIG. 12, one protrusion 347p protruding in a rectangular frame shape so as to surround eight grommet holes 347a is formed on the front end side of the grommet 347.

As shown in FIG. 13A, the metal terminal 71 attached to the separator 50 and crimped with the lead wire 48 (not shown) in the connection portion 71g in advance is inserted into the grommet hole 347a from the front end side of the grommet 347.

Then, as shown in FIG. 13B, as the grommet 347 is further advanced, the protrusion 347p is fitted into the separator 50. At this time, while an outer wall of the protrusion 347p contacts with the taper surface 50s, the outer wall is pressed toward the metal terminal 71 (rightward in FIG. 13B), to come into contact with the metal terminal 71.

Also in the fourth embodiment, the front end of the protrusion 347p is fitted into the rear end side relative to the front end of the taper surface 50s, along the axial-line-O direction.

Thus, the metal terminals 71 surely contact with the protrusions 347p.

In the fourth embodiment, in contrast to the first embodiment, the metal terminal 71 is placed such that the body portion 71f thereof faces the radially outer side relative to the connection portion 71g thereof. Thus, the protrusion 347p can contact with the metal terminal 71 by just being slightly pressed. As a matter of course, the metal terminal 71 may be placed such that the body portion 71f faces the radially inner side relative to the connection portion 71g, and the protrusion 347p may be further pressed and deformed.

As described above, in the fourth embodiment, the protrusion 347p is placed between the metal terminal 71 and the taper surface 50s.

Also in the second to fourth embodiments, the front end of the protrusion is fitted into the separator 50 so as to reach the front end side relative to ½ (or longer) of the length L in the axial-line-O direction, but the present disclosure is not limited thereto.

Needless to say, the present disclosure is not limited to the above embodiments and includes various modifications and equivalents encompassed in the idea and the scope of the present disclosure.

The shapes, the positions, and the number of the protrusions are not limited.

The separator 50 is not limited to the two-divided box shape and may be a tubular shape such as a cylindrical shape.

The disclosure has been described in detail with reference to the above embodiments. However, the disclosure should not be construed as being limited thereto. It should further be apparent to those skilled in the art that various changes in form and detail of the disclosure as shown and described above may be made. It is intended that such changes be included within the spirit and scope of the claims appended hereto.

This application is based on Japanese Patent Application No. 2023-220372 filed Dec. 27, 2023 and Japanese Patent Application No. 2024-163222 filed Sep. 20, 2024, the disclosures of which are incorporated herein by reference their entirety.

What is claimed is:

1. A gas sensor comprising:
a plate-shaped sensor element extending in an axial-line direction and having an electrode pad at a main surface on a rear end side thereof;
a metal terminal extending in the axial-line direction and electrically connected to the electrode pad;
a separator having a storage portion which penetrates in the axial-line direction and in which the rear end side of the sensor element and the metal terminal are stored, thus retaining the metal terminal; and
a grommet located on a rear end side relative to the separator, wherein
the storage portion has a taper surface whose diameter expands toward a direction perpendicular to the main surface as approaching a rearward-facing surface of the separator,
the grommet has a protrusion on a front end side, and a front end of the protrusion is fitted into a rear end side relative to a front end of the taper surface, along the axial-line direction, and
the metal terminal contacts with the protrusion.

2. The gas sensor according to claim 1, wherein
the front end of the protrusion is fitted into the separator so as to reach a front end side relative to ½ of a length L in the axial-line direction of the taper surface.

3. The gas sensor according to claim 1, wherein
the protrusion has a respective grommet hole into which the metal terminal is inserted, and
the metal terminal contacts with the protrusion, inside the grommet hole.

4. The gas sensor according to claim 2, wherein
the protrusion has a respective grommet hole into which the metal terminal is inserted, and
the metal terminal contacts with the protrusion, inside the grommet hole.

5. The gas sensor according to claim 1, wherein
a side surface of the protrusion is tapered toward a front end side along the taper surface, and
the metal terminal is held between the side surface of the protrusion and the taper surface.

6. The gas sensor according to claim 2, wherein
a side surface of the protrusion is tapered toward a front end side along the taper surface, and
the metal terminal is held between the side surface of the protrusion and the taper surface.

7. The gas sensor according to claim 1, wherein
the protrusion is located on an inner side relative to the metal terminal.

8. The gas sensor according to claim 2, wherein
the protrusion is located on an inner side relative to the metal terminal.

9. The gas sensor according to claim 1, wherein
the protrusion is located between the metal terminal and the taper surface.

10. The gas sensor according to claim 2, wherein
the protrusion is located between the metal terminal and the taper surface.

11. The gas sensor according to claim 1, wherein
the metal terminal contacts with a distal end of the protrusion.

12. The gas sensor according to claim 2, wherein
the metal terminal contacts with a distal end of the protrusion.
